(19) United States
(12) Patent Application Publication
(10) Pub. No.: US 2016/0162242 A1
(43) Pub. Date: Jun. 9, 2016

(54) DISPLAY APPARATUS AND METHOD FOR RENDERING DIGITAL CONTENT

(71) Applicants: SONY CORPORATION, Tokyo (JP); SONY NETWORK ENTERTAINMENT INTERNATIONAL LLC, Los Angeles, CA (US)

(72) Inventors: TRUE XIONG, SAN DIEGO, CA (US); CHARLES McCOY, CORONADO, CA (US); PRISCILIANO FLORES, SPRING VALLEY, CA (US); YUQIAN ZHAO, SAN DIEGO, CA (US)

(21) Appl. No.: 14/559,002

(22) Filed: Dec. 3, 2014

(51) Int. Cl. G06F 3/14; G09G 3/36; G09G 3/32; G06F 3/147

(52) U.S. Cl. CPC G06F 3/1431; G06F 3/147; G09G 3/36; G09G 3/3208; G09G 2300/023; G09G 2360/04

(57) ABSTRACT

Various aspects of a display apparatus and a method for rendering digital content are disclosed herein. The display apparatus comprises a display controller that is configured to dynamically control an active display layer and/or a passive display layer. The active display layer and/or the passive display layer activates a display region of a display screen of the display apparatus based on one or more parameters. The active display layer corresponds to a first display technology and the passive display layer corresponds to a second display technology.

### FIELD

Various embodiments of the disclosure relate to rendering digital content. More specifically, various embodiments of the disclosure relate to rendering digital content based on one or more parameters.

### BACKGROUND

Recent advancements in the field of digital technology have facilitated a diverse variety of features in digital devices, such as smartphones or tablets. Examples of the variety of features may include, but are not limited to, advanced applications, extended functionalities, and/or enhanced display screens. This variety of features may be utilized by the digital devices at a cost of an extended power supply. For example, enhanced display screens may consume unnecessary power during various activities, such as display of date/time in the full color range of the display screen.

In certain scenarios, an extended power supply may be compensated for in digital devices by use of advanced batteries. However, installation of such batteries in existing digital devices may require alteration of infrastructure of the hardware and/or software of such digital devices, which may be undesirable.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

A display apparatus and a method are provided for rendering digital content substantially as shown in, and/or described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram illustrating a network environment for rendering digital content, in accordance with an embodiment of the disclosure.

FIG. 2 is a block diagram illustrating an exemplary display apparatus, in accordance with an embodiment of the disclosure.

FIG. 3 illustrates an exemplary display screen, in accordance with an embodiment of the disclosure.

FIG. 4 illustrates a first exemplary scenario for implementing the disclosed apparatus and method for rendering digital content, in accordance with an embodiment of the disclosure.

FIG. 5 illustrates a second exemplary scenario for implementing the disclosed apparatus and method for rendering digital content, in accordance with an embodiment of the disclosure.

FIGS. 6A and 6B illustrate a third exemplary scenario for implementing the disclosed apparatus and method for rendering digital content, in accordance with an embodiment of the disclosure.

FIG. 7 is a flow chart illustrating an exemplary method for rendering digital content, in accordance with an embodiment of the disclosure.

### DETAILED DESCRIPTION

Exemplary aspects of the disclosure may comprise a method for rendering digital content. The method may be implemented in a display apparatus. The method may comprise dynamically controlling an active display layer and/or a passive display layer in the display apparatus based on one or more parameters. The active display layer and/or the passive display layer may be dynamically controlled to activate a region of a display screen of the display apparatus. In an embodiment, the active display layer may correspond to a first display technology. In an embodiment, the passive display layer may correspond to a second display technology.

In an embodiment, the first display technology may correspond to a liquid-crystal display (LCD) technology, a light-emitting diode (LED) display technology, and/or an organic light-emitting diode (OLED) display technology. In an embodiment, the second display technology may correspond to an electrophoretic ink (E-Ink) technology. In an embodiment, the active display layer may be configured to render dynamic digital content. The dynamic digital content may be associated with a first refresh rate. In an embodiment, the passive display layer may be configured to render static digital content. The static digital content may be associated with a second refresh rate. In an embodiment, the second refresh rate may be less than the first refresh rate.

In an embodiment, the display apparatus may comprise a backlight layer that may be configured to control a level of illumination of the display screen. In an embodiment, the display region of the display screen may comprise portions of one or more of the active display layer, the passive display layer, and the backlight layer. In an embodiment, a first set of display sub-regions of the active display layer and a second set of display sub-regions of the passive display layer may be dynamically controlled based on the one or more parameters. The one or more parameters may comprise a mode of the display apparatus, a type of digital content to be displayed, an ambient illumination, and/or one or more user preferences.

In an embodiment, the first set of display sub-regions of the active display layer and the second set of display sub-regions of the passive display layer may be selectively activated at a pixel level and/or a row level. In an embodiment, the mode of the display apparatus may correspond to an active mode or a passive mode. In an embodiment, the active mode may correspond to a display of dynamic digital content. In an embodiment, the passive mode may correspond to a display of static digital content. In an embodiment, the first set of display sub-regions and the second set of display sub-regions may be selectively enabled based on a level of the ambient illumination.

In an embodiment, the type of the digital content may correspond to dynamic digital content or static digital content. In an embodiment, the one or more user preferences may correspond to a manual selection of display settings, power-saver mode settings, and/or the like.

In an embodiment, a first display resolution of the active display layer may be greater than a second display resolution of the passive display layer. In an embodiment, the passive display layer may be stacked below the active display layer. In such a case, the first set of display sub-regions of the active display layer may be switched to a transparent mode and the second set of display sub-regions of the passive display layer may render static digital content. In an embodiment, the active display layer may be stacked below the passive display layer. In such a case, the first set of display sub-regions of the active display layer may render dynamic digital content and the second set of display sub-regions of the passive display layer may be switched to a transparent mode.

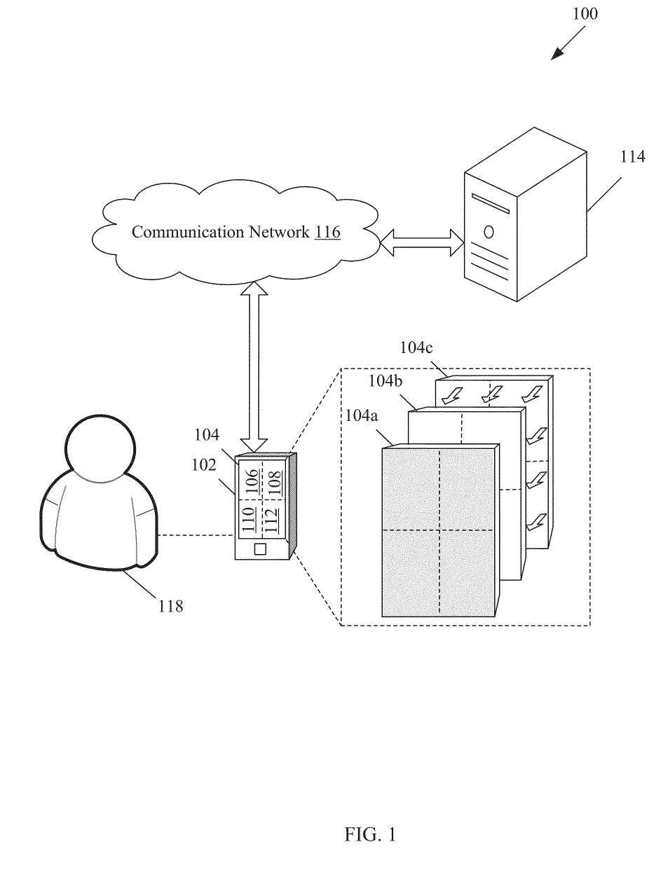

FIG. 1 is a block diagram illustrating a network environment for rendering digital content, in accordance with an embodiment of the disclosure. With reference to FIG. 1, a network environment 100 may comprise a display apparatus 102 and a display screen 104. The display screen 104 may be divided into a plurality of display regions, such as display regions 106, 108, 110, and 112. The network environment 100 may further comprise a server 114, a communication network 116, and a user 118. The display screen 104 may further comprise a plurality of layers, such as an active display layer 104a, a passive display layer 104b, and a backlight layer 104c. The display apparatus 102 may be communicatively coupled with the server 114, via the communication network 116. The display apparatus 102 may be associated with the user 118, via the display screen 104.

The display apparatus 102 may comprise suitable logic, circuitry, interfaces, and/or code that may be operable to render digital content, such as web content, on the display screen 104. In an embodiment, the display apparatus 102 may be operable to receive digital content from the server 114. In an embodiment, the display apparatus 102 may be operable to receive television (TV) signals from a network operator (not shown), decode the TV signals, and render the decoded TV signals on the display screen 104. Examples of the display apparatus 102 may include, but are not limited to, a television, an Internet Protocol Television (IPTV), a laptop, a tablet computer, a smartphone, and/or a Personal Digital Assistant (PDA) device.

The display screen 104 may comprise suitable logic, circuitry, interfaces, and/or code that may be operable to render the received digital content for the user 118. The display screen 104 may be further operable to render one or more features and/or applications of the display apparatus 102. The display screen 104 may comprise a plurality of display layers, such as the active display layer 104a, the passive display layer 104b, and the backlight layer 104c. In an embodiment, the plurality of display layers may be arranged as a stack of display layers. The size and shape of each of the plurality of display layers may differ from each other. In an embodiment, a portion of the display screen 104 may not include one or more of the plurality of display layers. For example, the display screen 104 may include a strip along an edge that may not comprise the active display layer 104a when such a strip is used to display status icons that may not change often. In an embodiment, the number and sequence of the plurality of display layers in the stack of display layers may vary in accordance with various exemplary scenarios. In accordance with an exemplary scenario, the stack of display layers may comprise multiple active display layers and no passive display layer. In accordance with another exemplary scenario, the stack of display layers may comprise multiple passive display layers and no active display layer. In accordance with another exemplary scenario, the stack of display layers may comprise multiple active display layers and multiple passive display layers. Notwithstanding, the disclosure may not be so limited, and the size, shape, number, and sequence of the plurality of display layers in the stack of display layers may be altered, without limiting the scope of the disclosure.

In an embodiment, the display screen 104 may further comprise a touchscreen that may be arranged adjacent to one of the plurality of display layers, such as the active display layer 104a, the passive display layer 104b, and/or the backlight layer 104c. Such a touchscreen may be operable to receive a touch-based input from the user 118. The touch-based input may be received from the user 118 via a virtual keypad, a stylus, and/or a gesture. The display screen 104 may be realized through several known technologies, such as, but not limited to, a Liquid Crystal Display (LCD) technology, a Light Emitting Diode (LED) display technology, an Organic LED (OLED) display technology, and/or an electrophoretic ink (EInk).

The display regions 106, 108, 110, and 112 may correspond to a plurality of display portions of the display screen 104. The display apparatus 102 may be operable to selectively activate one or more of the display regions 106, 108, 110, and 112, to render the digital content based on one or more parameters. The one or more parameters may include a mode of the display apparatus 102, a type of the digital content to be displayed by the display apparatus 102, an ambient illumination, one or more user preferences, and/or the like. For simplicity, there is shown in FIG. 1 the display screen 104, which is divided into four display regions 106, 108, 110, and 112. Notwithstanding, the disclosure may not be so limited, and the display screen 104 may be divided into more than four display regions without limiting the scope of the disclosure.

The server 114 may comprise suitable logic, circuitry, interfaces, and/or code that may be operable to host web content for one or more subscribed devices, such as the display apparatus 102. In an embodiment, the server 114 may be communicatively coupled with a network operator configured to send TV signals to the display apparatus 102. The network operator may be configured to stream one or more channels to the display apparatus 102. The server 114 may include web content, such as, an e-book, a live broadcast of a soccer match, and/or an online still image. Examples of the server 114 may include, but are not limited to, a content server, a web server, and/or a multimedia server.

The communication network 116 may include a medium through which the display apparatus 102 may communicate with the server 114. Examples of the communication network 116 may include, but are not limited to, the Internet, a cloud network, a Wireless Fidelity (Wi-Fi) network, a Wireless Local Area Network (WLAN), a Local Area Network (LAN), a telephone line (POTS), and/or a Metropolitan Area Network (MAN). Various devices in the network environment 100 may be operable to connect to the communication network 116, in accordance with various wired and wireless communication protocols. Examples of such wired and wireless communication protocols may include, but are not limited to, Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR), IEEE 802.11, 802.16, cellular communication protocols, and/or Bluetooth (BT) communication protocols.

The user 118 may be associated with the display apparatus 102. The user 118 may provide a touch-based input to the display apparatus 102, when the display screen 104 comprises a touchscreen layer. In an embodiment, the user 118 may view digital content, such as a movie, an e-book, or another multimedia content, rendered on the display screen 104. Notwithstanding, the disclosure may not be so limited, and more than one user may be associated with the display apparatus 102, without limiting the scope of the disclosure.

In operation, the display apparatus 102 may receive digital content from the server 114 or a network operator (not shown), via the communication network 116. In an embodiment, the display apparatus 102 may be operable to retrieve digital content pre-stored in a local memory of the display apparatus 102. In an embodiment, the digital content may correspond to online web content or multimedia content received from the server 114. In an embodiment, the digital content may correspond to television (TV) signals received from the network operator. In an embodiment, the digital content may correspond to image-based files or video-based files that may be pre-stored in a local memory of the display apparatus 102.

The plurality of display layers, such as the active display layer 104a, the passive display layer 104b, and the backlight layer 104c, may correspond to a plurality of display technologies. In an embodiment, the active display layer 104a may correspond to a first display technology of a plurality of display technologies. Examples of the first display technology may include, but are not limited to, a liquid-crystal display (LCD) technology, a light-emitting diode (LED) display technology, and/or an organic light-emitting diode (OLED) display technology. In an embodiment, the passive display layer 104b may correspond to a second display technology of the plurality of display technologies. The second display technology that corresponds to the passive display layer 104b may consume little or no power when the displayed digital content does not change. An example of the second display technology may include, but is not limited to, an electrophoretic ink (E-Ink) technology. In an embodiment, the backlight layer 104c may illuminate the remaining display layers, such as the active display layer 104a and/or the passive display layer 104b, which may be stacked above the backlight layer 104c. In an exemplary scenario, the active display layer 104a may be arranged in front of the passive display layer 104b and/or backlight layer 104c. In another exemplary scenario, the backlight layer 104c may be arranged in front of the active display layer 104a and/or the passive display layer 104b. In another exemplary scenario, the passive display layer 104b may be arranged in front of the active display layer 104a and/or backlight layer 104c. In such exemplary scenarios, the front display layer may be switched to a transparent mode when not displaying the digital content. In such a case, the other display layer behind the front display layer may render the digital content, and the user 118 may view the rendered digital content through the front display layer that is switched to a transparent mode. Although, there are shown single instances of three display layers in a specific sequence, the disclosure may not be so limited, and the number of such instances and the sequence of the plurality of display layers in the stack of display layers may vary, without limiting the scope of the disclosure.

In an embodiment, the active display layer 104a may be operable to render dynamic digital content, such as a movie, a news channel, and/or a live soccer match. In an embodiment, the passive display layer 104b may be operable to render static digital content, such as an e-book, and/or a date/time display. In an embodiment, a first refresh rate may be associated with the dynamic digital content, and a second refresh rate may be associated with the static digital content. In an embodiment, the first refresh rate may be greater than the second refresh rate. For example, the passive display layer 104b may display the static digital content, such as the score of the live soccer match, as the associated first refresh rate may be less than the second refresh rate of the rest of the dynamic digital content. The dynamic digital content, such as the live video of the live soccer match, may be displayed by the active display layer 104a.

In an embodiment, the display apparatus 102 may be operable to dynamically control the active display layer 104a and/or the passive display layer 104b. The active display layer 104a and/or the passive display layer 104b may be dynamically controlled, such that the display regions 106 to 108 may be selectively activated based on the one or more parameters. Examples of such one or more parameters may include, but are not limited to, a mode of the display screen 104, a type of digital content to be displayed by the display screen 104, an ambient illumination, and/or one or more user preferences.

In an embodiment, the mode of the display screen 104 may be an active mode that may correspond to a display of the dynamic digital content. In an embodiment, the mode of the display screen 104 may be a passive mode that may correspond to a display of the static digital content. In an embodiment, the type of the digital content may correspond to dynamic digital content or static digital content that may be displayed by the display screen 104. In an embodiment, the plurality of display regions of each of the plurality of display layers may be selectively activated when the ambient illumination is less than a pre-determined first threshold value. In an embodiment, the display apparatus 102 may compensate for the ambient illumination when the ambient illumination is greater than the pre-determined first threshold value. In an embodiment, the plurality of display regions of each of the plurality of display layers may be determined by the display apparatus 102. In an embodiment, the plurality of display regions of each of the plurality of display layers may be determined based on an input provided by the user 118. In an embodiment, the one or more user preferences may correspond to a manual selection of parameters, such as profile configuration settings and/or power-saver mode settings.

In an embodiment, the display apparatus 102 may be operable to selectively activate the display regions 106, 108, 110, and 112 of the display screen 104. In an embodiment, when the display screen 104 is in the passive mode, the display apparatus 102 may selectively activate the display regions 106, 108, 110, and 112, such that the active display layer 104a may switch to a transparent mode and the passive display layer 104b may render the static digital content. In an embodiment, when the display screen 104 is in the active mode, the display apparatus 102 may selectively activate the display regions 106, 108, 110, and 112, such that the active display layer 104a may render the dynamic digital content in full color mode, and the passive display layer 104b may switch to a transparent mode. In an embodiment, when the display screen 104 is in the passive mode, the display apparatus 102 may selectively activate the display regions 106, 108, 110, and 112, such that the active display layer 104a may switch to a transparent mode and the passive display layer 104b may render the static digital content monochromatically. In an embodiment, the display apparatus 102 may be operable to selectively activate the display regions 106, 108, 110, and 112, which may correspond to each of the plurality of display layers at a pixel level and/or a row level. In an embodiment, a resolution of the active display layer 104a may be greater than a resolution of the passive display layer 104b.

In an embodiment, the local memory may comprise one or more adaptive algorithms. The one or more adaptive algorithms may be executed to monitor the digital content, and move the dynamic portion of the digital content to the active display layer 104a and static portion of the digital content to the passive display layer 104b. The one or more adaptive algorithms may be implemented based on information, such as refresh rate, about the digital content being displayed in a display region of the display screen 104. For example, the display region 106 that displays a video may be rendered by the active display layer 104a while the display region 108 that displays static text or images may be rendered by the passive display layer 104b. In an instance, a portion of the digital content may require a range of colors or a resolution that may be available in a subset of the plurality of display layers. In such a case, a display layer from the subset with desired characteristics may be chosen to display the portion of the digital content. In an embodiment, the one or more adaptive algorithms may be implemented based on an ambient light sensor (not shown) that may be used to determine which display layer is to be used to render the digital content. In accordance with an exemplary scenario, a cell-phone may be switched from usage of an active display layer to usage of a passive display layer when the ambient light sensor senses that the level of the ambient illumination exceeds the pre-determined first threshold value. In accordance with another exemplary scenario, the cell-phone may be switched from the usage of the passive display layer to usage of the active display layer when the ambient light sensor senses that the level of the ambient illumination is less than the pre-determined first threshold value. In accordance with another exemplary scenario, the cell-phone may be switched from the usage of a first active display layer that exhibits better energy efficiency, better resolution, or better color representation to usage of a second active display layer when the ambient light sensor senses that it may be easier to read in bright light.

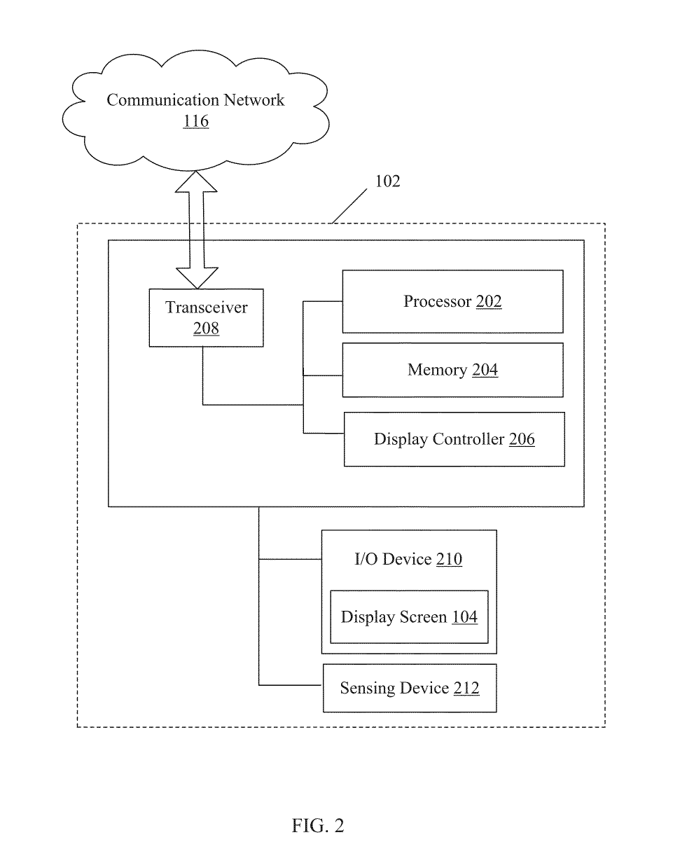

FIG. 2 is a block diagram illustrating an exemplary display apparatus, in accordance with an embodiment of the disclosure. FIG. 2 is explained in conjunction with elements from FIG. 1. With reference to FIG. 2, there is shown the display apparatus 102. The display apparatus 102 may comprise one or more processors, such as a processor 202, a memory 204, a display controller 206, a transceiver 208, one or more Input-Output (I/O) devices, such as an I/O device 210, and a sensing device 212. The processor 202 may be communicatively connected with the server 114, via the transceiver 208.

The processor 202 may comprise suitable logic, circuitry, interfaces, and/or code that may be operable to execute a set of instructions stored in the memory 204. The processor 202 may be communicatively coupled with the memory 204, the transceiver 208, and the I/O device 210. The processor 202 may be operable to render the digital content received from the server 114. The processor 202 may be implemented based on a number of processor technologies known in the art. Examples of the processor 202 may be an X86-based processor, a Reduced Instruction Set Computing (RISC) processor, an Application-Specific Integrated Circuit (ASIC) processor, a Complex Instruction Set Computing (CISC) processor, and/or any other processor.

The memory 204 may comprise suitable logic, circuitry, interfaces, and/or code that may be operable to store the set of instructions, which may be executed by the processor 202. The memory 204 may further include one or more computer vision algorithms that may be executed by the processor 202, to render the digital content received from the server 114. The memory 204 may be implemented based on, but not limited to, a Random Access Memory (RAM), a Read-Only Memory (ROM), a Hard Disk Drive (HDD), a storage server and/or a Secure Digital (SD) card.

The display controller 206 may comprise suitable logic, circuitry, interfaces, and/or code that may be operable to selectively activate one or more display regions of the display screen 104. The display controller 206 may selectively activate the one or more display regions based on the one or more parameters. In an embodiment, the display controller 206 may provide a selective power supply to the plurality of display layers. For example, the active display layer 104a may switch to a transparent mode and the passive display layer 104b may render digital content in the monochrome color range. In an embodiment, the display controller 206 may provide a selective power supply to the plurality of display layers. For example, the active display layer 104a may render digital content in full color mode and the passive display layer 104b may switch to a transparent mode.

The transceiver 208 may comprise suitable logic, circuitry, interfaces, and/or code that may be operable to communicate with the server 114, and/or the television broadcast station (not shown), via various communication interfaces. The transceiver 208 may implement known technologies to support wired or wireless communication with the communication network 116. The transceiver 208 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, and/or a local buffer. The transceiver 208 may communicate via wireless communication with networks, such as the Internet, an Intranet and/or a wireless network, such as a cellular telephone network, a wireless local area network (LAN) and/or a metropolitan area network (MAN). The wireless communication may use any of a plurality of communication standards, protocols and technologies, such as Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS).

The I/O device 210 may comprise suitable logic, circuitry, interfaces, and/or code that may be operable to receive an input or provide an output to the user 118. The I/O device 210 may comprise various input and output devices that may be operable to communicate with the processor 202. Examples of the input devices may include, but are not limited to, a keyboard, a mouse, a joystick, a touchscreen, a microphone, a camera, and/or a docking station. Examples of the output devices may include, but are not limited to, the display screen 104, and/or a speaker.

The sensing device 212 may comprise suitable logic, circuitry, and/or interfaces that may be operable to include one or more sensors configured to detect one or more environmental conditions. The one or more environmental conditions, such as ambient illumination and/or motion information, may be detected by the sensing device 212.

In operation, the transceiver 208 of the display apparatus 102 may receive digital content from the server 114, or a network operator (not shown), via the communication network 116. The transceiver 208 may communicate the received digital content to the processor 202. In an embodiment, the processor 202 may be operable to retrieve the digital content that may be pre-stored in the memory 204.

In an embodiment, the processor 202 may be operable to determine one or more parameters associated with the display screen 104 and/or the digital content. The one or more parameters may include a mode of the display screen 104, a type of digital content to be displayed by the display screen 104, an ambient illumination, one or more user preferences, and/or the like. In an embodiment, the processor 202 may determine the mode of the display screen 104 as an active mode, when the active display layer 104a renders dynamic digital content, such as movie. In an embodiment, the processor 202 may determine the mode of the display screen 104 as a passive mode, when the passive display layer 104b renders static digital content, such as an e-book.

In an embodiment, the processor 202 may determine the type of the digital content to be displayed by the display screen 104, based on a refresh rate of the digital content. In an embodiment, when the refresh rate associated with the digital content is greater than a predetermined second threshold value, the processor 202 may determine the type of the digital content to be dynamic digital content. For example, the refresh rate associated with a video may be greater than the predetermined second threshold value, since the associated frames are refreshed after short time intervals. In an embodiment, the processor 202 may determine the type of the digital content as static digital content when the refresh rate associated with the digital content is less than the predetermined second threshold value. For example, the refresh rate associated with an e-book is less than the predetermined second threshold value, since the associated frames are refreshed after long time intervals.

In an embodiment, the sensing device 212 may be operable to detect one or more environment conditions, such as ambient illumination and/or motion information, with respect to the display apparatus 102. The sensing device 212 may communicate such detected one or more environment conditions to the processor 202. In an embodiment, the processor 202 may determine that the ambient illumination is less than the pre-determined first threshold value. Based on the determination, the processor 202 may be operable to selectively activate a plurality of display regions, such as the display regions 106, 108, 110, and 112 of the display screen 104. In an embodiment, the processor 202 may determine the motion information of the digital content to be greater than a pre-determined third threshold value. Based on the determined motion information of the digital content, the processor 202 may further determine that the digital content is static digital content or dynamic digital content. Based on the determination, the processor 202 may be operable to selectively activate a plurality of display regions, such as the display regions 106, 108, 110, and 112 of the display screen 104.

In an embodiment, the processor 202 may determine the one or more user preferences based on an automatic or a manual selection of configuration settings of the display apparatus 102. Such an automatic selection may be based on the one or more environmental conditions detected by the sensing device 212. In an embodiment, the processor 202 may determine the mode of the display apparatus 102 to be a passive mode, when the sensing device 212 detects that the battery level of the display apparatus 102 is less than a predetermined fourth threshold value. In an embodiment, the processor 202 may determine the mode of the display apparatus 102 as a passive mode, when the sensing device 212 detects that the display apparatus 102 is idle for a pre-specified time duration. The manual selection of configuration settings may correspond to profile configuration settings and/or power-saver mode settings, as performed by the user 118.

In an embodiment, the processor 202 may be operable to communicate the determined one or more parameters to the display controller 206. Based on the one or more parameters received from the processor 202, the display controller 206 may be operable to selectively activate the plurality of display regions 106, 108, 110, and 112 of the display screen 104. The display controller 206 may be operable to render the digital content on the display screen 104, based on the selectively activated plurality of display regions 106, 108, 110, and 112.

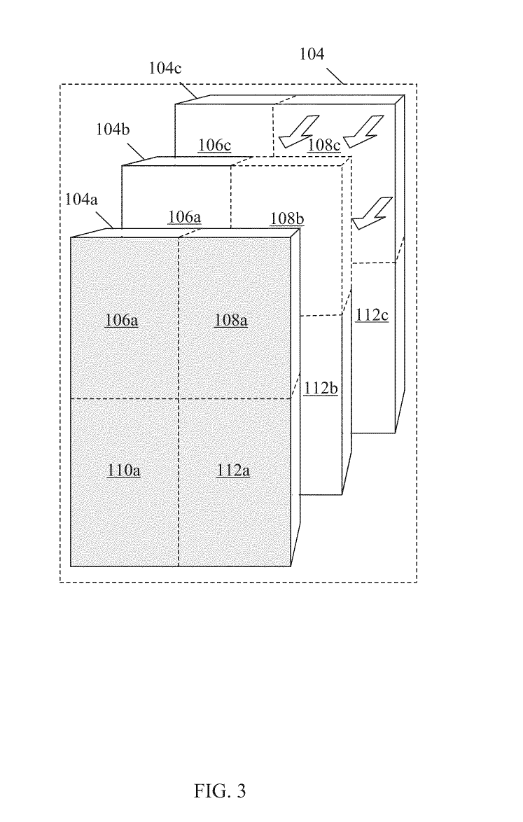

FIG. 3 illustrates an exemplary display screen, in accordance with an embodiment of the disclosure. FIG. 3 is explained in conjunction with elements from FIG. 1 and FIG. 2. With reference to FIG. 3, the plurality of display layers in the display screen 104 may comprise the active display layer 104a, the passive display layer 104b, and the backlight layer 104c. In an embodiment, the active display layer 104a, the passive display layer 104b, and the backlight layer 104c may be arranged as a stack of display layers. Notwithstanding, the disclosure may not be so limited, and other arrangements of the plurality of display layers in the display screen 104 may be implemented, without limiting the scope of the disclosure.

The active display layer 104a may comprise a first set of display sub-regions that may include display sub-regions 106a, 108a, 110a, and 112a. The passive display layer 104b may comprise a second set of display sub-regions that may include display sub-regions 106b, 108b, 110b, and 112b. The backlight layer 104c may comprise a third set of display sub-regions that may include display sub-regions 106c, 108c, 110c, and 112c. Notwithstanding, the disclosure may not be so limited, and each of the plurality of display screens may comprise more than four display sub-regions, without limiting the scope of the disclosure.

The active display layer 104a may correspond to a first display technology, such as a light-emitting diode (LED) display technology, and/or an organic light-emitting diode (OLED) display technology. The passive display layer 104b may correspond to a second display technology, such as the electrophoretic ink (E-Ink) technology. The backlight layer 104c may illuminate the other display layers, such as the active display layer 104a and the passive display layer 104b.

In an embodiment, each display sub-region, such as 106a, 106b, and 106c, from the first set, the second set, and the third set of display sub-regions, respectively, may be arranged as a stack of display sub-regions. Such a stack of display sub-regions may correspond to the display region 106 of the display screen 104. Similarly, other stacks of the display sub-regions from the first set, the second set, and the third set of one or more display regions may correspond to the display regions 108, 110, and 112, respectively, of the display screen 104.

In an embodiment, every frame of the digital content rendered on the display screen 104 may be divided into four portions. Each portion of the digital content frame may correspond to the four display regions, such as 106, 108, 110, and 112, of the display screen 104. The processor 202 may be operable to determine one or more parameters associated with the plurality of display regions of the display screen 104. The processor 202 may be further operable to determine one or more parameters associated with the one or more portions of the digital content to which the plurality of display regions correspond. In an embodiment, the processor 202 may determine that level of illumination of a portion of the rendered digital content, which corresponds to the display region 108 of the display screen 104, may be less than the pre-determined first threshold value. The processor 202 may be operable to communicate the determined one or more parameters to the display controller 206.

In an embodiment, based on the one or more parameters received from the processor 202, the display controller 206 may be operable to selectively activate the plurality of display sub-regions of each of the plurality of display layers. The display sub-region 108a, of the active display layer 104a, may be selectively activated to render the digital content. The display sub-region 108b, of the passive display layer 104b, may be selectively activated to switch to a transparent mode. The display sub-region 108c, of the backlight layer 104c, may be selectively activated to illuminate the display sub-regions 108a and 108b.

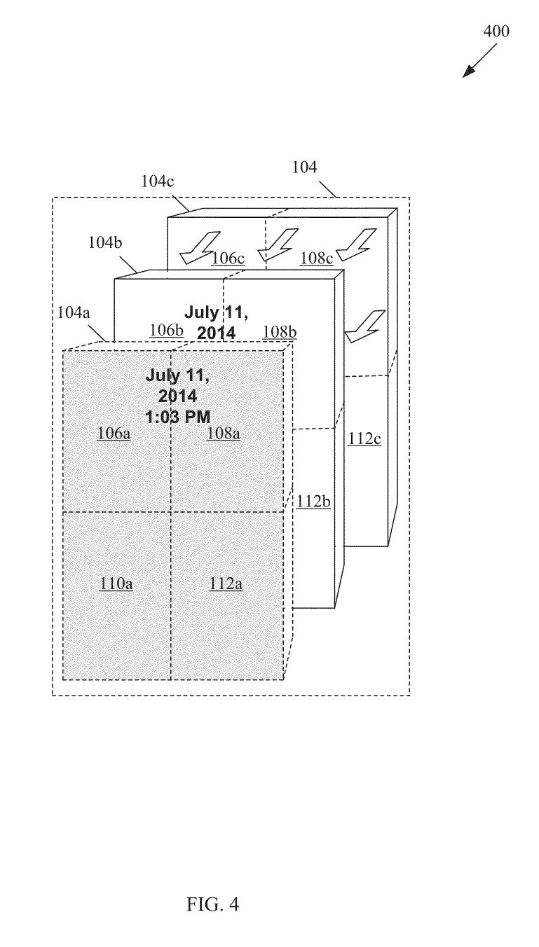

FIG. 4 illustrates a first exemplary scenario 400 for implementing the disclosed apparatus and method for rendering digital content, in accordance with an embodiment of the disclosure. FIG. 4 is explained in conjunction with elements from FIG. 1, FIG. 2, and FIG. 3. With reference to FIG. 4, there is shown a first arrangement of the plurality of display layers of the display screen 104.

With reference to FIG. 4, the digital content may be a current date and time, such as, “Jul. 11, 2014; 1:03 PM”, which may be rendered in a monochrome color range on the display screen 104. The processor 202 may analyze the digital content to determine the mode of the display screen 104 as a passive mode. The processor 202 may further determine the type of the digital content as a static digital content as the date and time display may be refreshed once per minute. The processor 202 may further determine that the level of illumination of a portion of the rendered digital content, which corresponds to the display region 106 and 108 of the display screen 104, to be less than the pre-determined first threshold value.

The processor 202 may be operable to communicate the determined one or more parameters to the display controller 206. Based on the one or more parameters, the display controller 206 may be operable to selectively activate a plurality of display sub-regions of each of the plurality of display layers. The display controller 206 may selectively activated the display sub-regions 106a and 108a, of the active display layer 104a, to switch to transparent mode. The display controller 206 may selectively activate the display sub-regions 108a and 108b, of the passive display layer 104b, to render the static digital content in the monochrome color range. The display controller 206 may selectively activate the display sub-regions 108a and 108c, of the backlight layer 104c. The selective activation may illuminate the display sub-regions 106a and 108a of the active display layer 104a. The selective activation may further illuminate the display sub-regions 106b and 108b of passive display layer 104b.

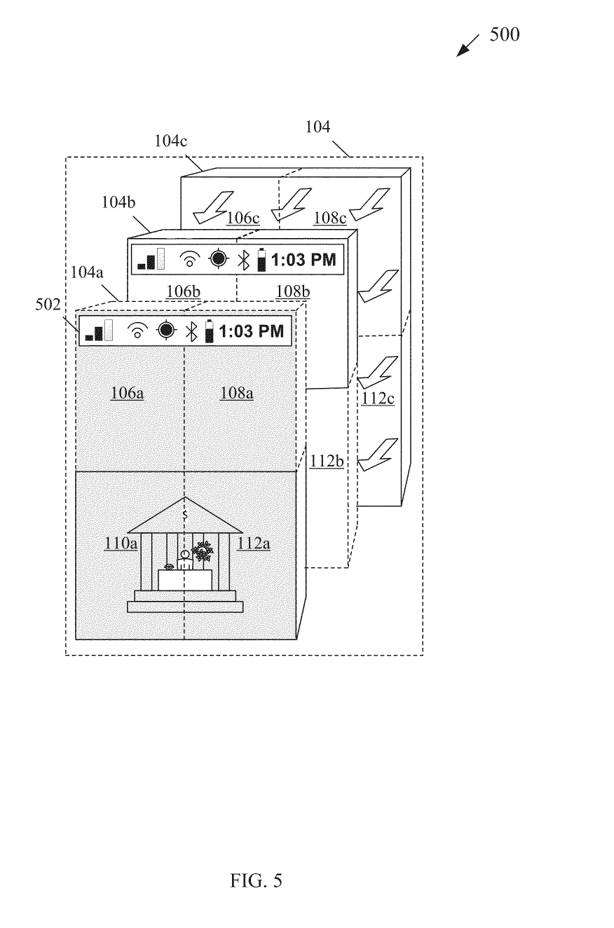

FIG. 5 illustrates a second exemplary scenario 500 for implementing the disclosed apparatus and method for rendering digital content, in accordance with an embodiment of the disclosure. FIG. 5 is explained in conjunction with elements from FIG. 1, FIG. 2, and FIG. 3. With reference to FIG. 5, there is shown a second arrangement of the plurality of display layers of the display screen 104.

With reference to FIG. 5, the digital content may comprise static digital content, such as a plurality of status indicators displayed in a status bar 502. Examples of the plurality of status indicators may include, but are not limited to, a signal strength indicator, a wireless fidelity (Wi-Fi) indicator, a geographical position system (GPS) indicator, a Bluetooth indicator, a battery level indicator, and/or a time indicator. The display controller 206 may be further operable to provide selective power to the four regions, such as 106c to 112c, of the backlight layer 104c, to illuminate the active display layer 104a and the passive display layer 104b.

The digital content may further comprise dynamic digital content, such as a video clip. The digital content may be rendered on the display screen 104 of the display apparatus 102. The processor 202 may analyze the digital content to determine the mode of the display screen 104. The mode may be determined as a combination of passive mode and active mode. The passive mode may correspond to the static digital content, such as the status bar 502. The active mode may correspond to the dynamic digital content, such as the video clip. The processor 202 may further determine the type of the digital content to be displayed by the display screen 104. The type of digital content may be a combination of static digital content and dynamic digital content. The refresh rate of the static digital content may be less than the predetermined second threshold value. The refresh rate of the dynamic digital content may be greater than the predetermined second threshold value.

The processor 202 may be operable to communicate the determined one or more parameters to the display controller 206. In an embodiment, based on the one or more parameters received from the processor 202, the display controller 206 may be operable to selectively activate the plurality of display sub-regions of each of the plurality of display layers. The display controller 206 may selectively activate the display sub-regions 106a and 108a, of the active display layer 104a, to switch to a transparent mode. The display controller 206 may selectively activate the display sub-regions 110a and 112a, of the active display layer 104a, to render the dynamic digital content in full color range. The display controller 206 may selectively activate the display sub-regions 106b and 108b, of the passive display layer 104b, to render the static digital content in a monochrome color range. The display controller 206 may selectively activate the display sub-regions 110b and 112b, of the passive display layer 104b, to switch to a transparent mode. The display controller 206 may selectively activate the display sub-regions 106c, 108c, 110c, and 112c, of the backlight layer 104c, to illuminate the display sub-regions of the active display layer 104a, and the passive display layer 104b.

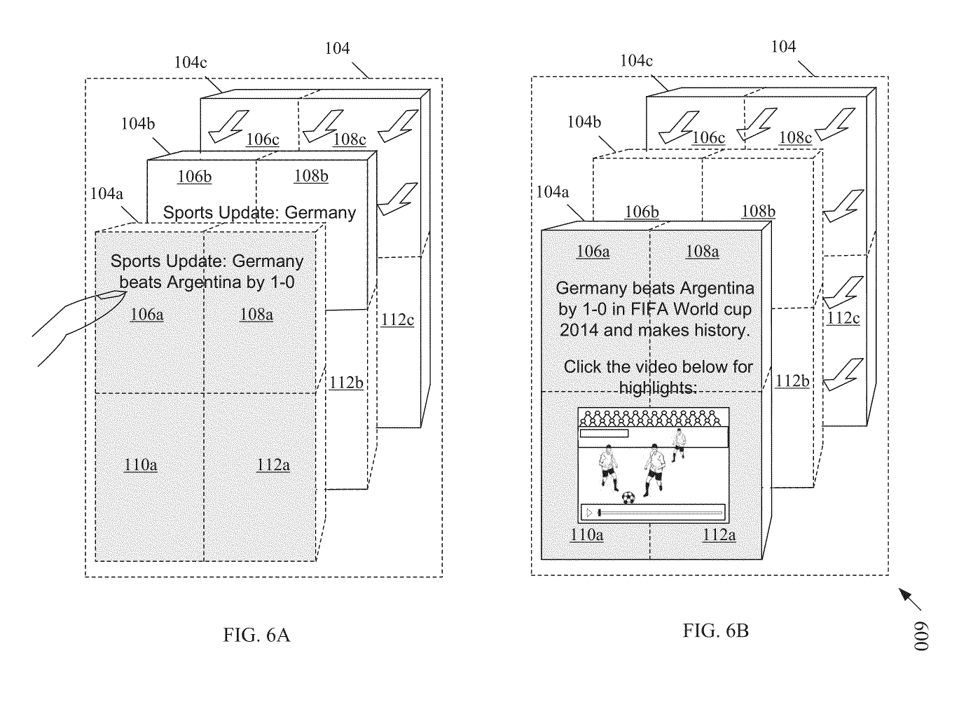

FIG. 6, composed of FIGS. 6A and 6B, illustrate a third exemplary scenario 600 for implementing the disclosed apparatus and method for rendering digital content, in accordance with an embodiment of the disclosure. FIG. 6 is explained in conjunction with elements from FIG. 1, FIG. 2, and FIG. 3. With reference to FIG. 6, there is shown a third arrangement of the plurality of display layers of the display screen 104.

With reference to FIG. 6A, content that may be rendered on the display screen 104 may be static digital content, such as a message, “Sports Update: Germany beats Argentina by 1-0”. Such static digital content may be rendered in a monochrome color range. The processor 202 may analyze the digital content to determine the mode of the display screen 104 as a passive mode. The processor 202 may further determine the type of the digital content to be displayed by the display screen 104 as the static digital content. The static digital content may be the message, “Sports Update: Germany beats Argentina by 1-0”, which may not be required to be refreshed. In an embodiment, the processor 202 may further determine the level of illumination of the rendered digital content that corresponds to the display regions 106 and 108, of the display screen 104, to be less than the pre-determined first threshold value.

The processor 202 may be operable to communicate the determined one or more parameters to the display controller 206. In an embodiment, based on the one or more parameters received from the processor 202, the display controller 206 may be operable to selectively activate the plurality of display sub-regions of each of the plurality of display layers. The display controller 206 may be operable to selectively activate the display sub-regions 106a to 112a, of the active display layer 104a, to switch to a transparent mode. The display sub-regions 106b and 108b, of the passive display layer 104b, may be selectively activated to render the message, “Sports Update: Germany beats Argentina by 1-0”, in the monochrome color range. The display sub-regions 110b and 112b, of the passive display layer 104b, may be selectively activated to switch to a transparent mode. The display sub-regions 106c and 108c, of the backlight layer 104c, may be selectively activated to illuminate the other display sub-regions.

In an embodiment, the user 118 may provide a touch-based input, such as a tap gesture, on the message, “Sports Update: Germany beats Argentina by 1-0”, which may be rendered on the display screen 104. Based on the touch-based input provided by the user 118, the processor 202 may be operable to determine a new set of one or more parameters related to a new digital content. Such new digital content may be related to the message, “Sports Update: Germany beats Argentina by 1-0”, which may be rendered on the display screen 104. The new digital content may comprise a detailed digital content, such as a new message, “Germany beats Argentina by 1-0 in FIFA World cup 2014 and makes history. Click the video below for highlights”. The detailed digital content may be rendered on the display screen 104, via dynamic rendering software, such as the Adobe® Flash® Player. The new dynamic digital content may comprise a video content, such as a video clip that may show the highlights when selected by the user 118, via a click event. Such a video clip may be required to be refreshed after every fraction of a second while rendered on the display screen 104.

With reference to FIG. 6B, the processor 202 may analyze the new digital content to determine the mode of the display screen 104 as an active mode. The processor 202 may further determine the type of the new digital content to be displayed by the display screen 104. Based on the refresh rate, the type of new digital content may be dynamic digital content. In an embodiment, the processor 202 may further determine the level of illumination of the rendered new digital content that corresponds to the display regions 106, 108, 110, and 112, of the display screen 104, to be less than the pre-determined first threshold value.

The processor 202 may be operable to communicate the determined one or more parameters to the display controller 206. In an embodiment, based on the one or more parameters received from the processor 202, the display controller 206 may be operable to selectively activate the plurality of display sub-regions of each of the plurality of display layers. The display controller 206 may be operable to selectively activate the display sub-regions 106a to 112a, of the active display layer 104a, to render the dynamic digital content, such as the new message and the video clip, in full color range. The display sub-regions 106b to 112b, of the passive display layer 104b, may be selectively activated to switch to a transparent mode. The display sub-regions 106c to 112c, of the backlight layer 104c, may be selectively activated to illuminate the display sub-regions of the active display layer 104a, and the passive display layer 104b.

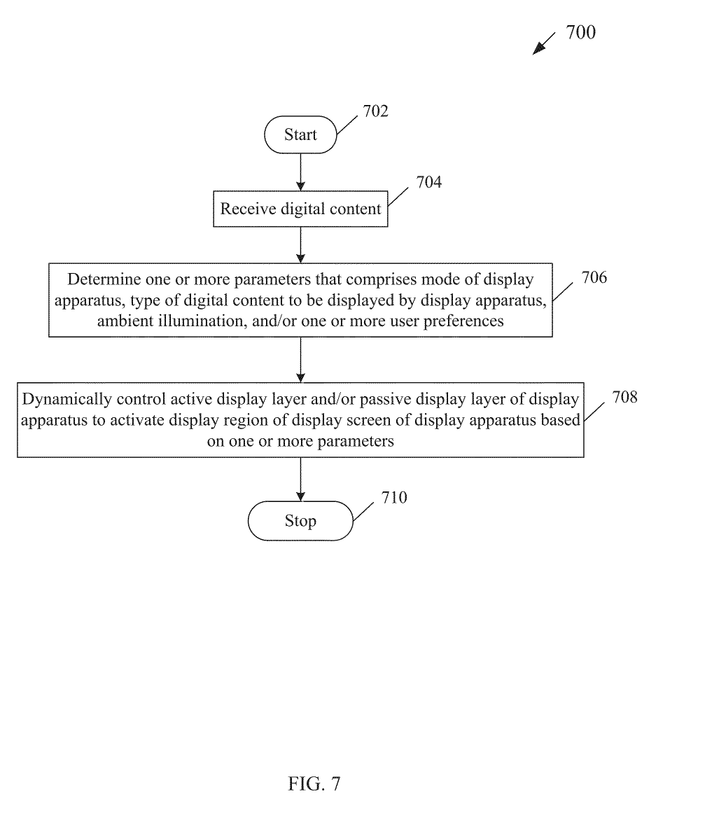

FIG. 7 is a flowchart illustrating an exemplary method for rendering digital content, in accordance with an embodiment of the disclosure. FIG. 7 is described in conjunction with elements of FIG. 1, FIG. 2, FIG. 3, and FIG. 4. The method 700 may be implemented in the display apparatus 102, which may be communicatively coupled with the server 114.

The method 700 begins at step 702 and proceeds to step 704. At step 704, the digital content may be received. At step 706, the one or more parameters may be determined. The one or more parameters may comprise a mode of the display apparatus 102, a type of the digital content to be displayed by the display apparatus 102, an ambient illumination, and/or one or more user preferences. At step 718, the active display layer 104a and/or the passive display layer 104b may be dynamically controlled. The active display layer 104a and/or the passive display layer 104b may be dynamically controlled, such that the display regions 106 to 108 may be selectively activated based on the one or more parameters. Control passes to end step 710.

In accordance with an embodiment of the disclosure, the display apparatus 102 (FIG. 1) may be communicatively coupled with the server 114 (FIG. 1). The display apparatus 102 may comprise one or more processors, such as the processor 202 (FIG. 2). The processor 202 may be operable to receive digital content from the server 114. The display apparatus 102 may comprise the active display layer 104a (FIG. 1), which may correspond to a first display technology. The display apparatus 102 may further comprise the passive display layer 104b (FIG. 1), which may correspond to a second display technology. The display apparatus 102 may further comprise a display controller 206 (FIG. 2), which may be configured to dynamically control the active display layer 104a and/or the passive display layer 104b. Dynamic control may activate a display region of the display screen 104 of the display apparatus 102, based on one or more parameters.

Various embodiments of the disclosure may provide a non-transitory computer readable medium and/or storage medium, and/or a non-transitory machine readable medium and/or storage medium having stored thereon, a machine code and/or a computer program having at least one code section executable by a machine and/or a computer for rendering digital content. The at least one code section in an electronic device may cause the machine and/or computer to perform the steps comprising, in a display device, dynamically controlling the an active display layer and/or a passive display layer to activate a display region of the display screen of the display apparatus based on one or more parameters.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted for carrying out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

The present disclosure may also be embedded in a computer program product, which comprises all the features activating the implementation of the methods described herein, and which when loaded in a computer system is able to carry out these methods. Computer program, in the present context, means any expression, in any language, code or notation, of a set of instructions intended to cause a system having an information processing capability to perform a particular function either directly, or after either or both of the following: a) conversion to another language, code or notation; b) reproduction in a different material form.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

What is claimed is:

1. A display apparatus for rendering digital content, the display apparatus comprising:
an active display layer that corresponds to a first display technology;
a passive display layer that corresponds to a second display technology; and
a display controller that is configured to dynamically control said active display layer and/or said passive display layer to activate a display region of a display screen of said display apparatus based on one or more parameters.

2. The display apparatus according to claim 1, wherein said first display technology corresponds to one of: a liquid-crystal display (LCD) technology, a light-emitting diode (LED) display technology, or an organic light-emitting diode (OLED) display technology.

3. The display apparatus according to claim 1, wherein said second display technology corresponds to an electrophoretic ink (E-Ink) technology.

4. The display apparatus according to claim 1, wherein said active display layer is configured to render dynamic digital content that is associated with a first refresh rate.

5. The display apparatus according to claim 4, wherein said passive display layer is configured to render static digital content that is associated with a second refresh rate, wherein said second refresh rate is less than said first refresh rate.

6. The display apparatus according to claim 1, further comprising a backlight layer configured to control a level of illumination of said display screen.

7. The display apparatus according to claim 6, wherein said display region of said display screen comprises portions of one or more of: said active display layer, said passive display layer, and said backlight layer.

8. The display apparatus according to claim 1, wherein said display controller dynamically controls a first set of display sub-regions of said active display layer and a second set of display sub-regions of said passive display layer based on said one or more parameters, wherein said one or more parameters comprise one or more of: a mode of said display apparatus, a type of digital content to be displayed by said display apparatus, an ambient illumination, and/or one or more user preferences.

9. The display apparatus according to claim 8, wherein said display controller selectively activates said first set of display sub-regions and said second set of display sub-regions at a pixel level and/or a row level.

10. The display apparatus according to claim 8, wherein said mode of said display apparatus corresponds to one of: an active mode, or a passive mode, wherein said active mode corresponds to display of dynamic digital content and said passive mode corresponds to display of static digital content.

11. The display apparatus according to claim 8, wherein said first set of display sub-regions and said second set of display sub-regions are selectively enabled based on a level of said ambient illumination.

12. The display apparatus according to claim 8, wherein said type of said digital content corresponds to one of: dynamic digital content, or static digital content.

13. The display apparatus according to claim 8, wherein said one or more user preferences correspond to a manual selection of one or more of: display settings and/or power-saver mode settings.

14. The display apparatus according to claim 1, wherein a first display resolution of said active display layer is greater than a second display resolution of said passive display layer.

15. The display apparatus according to claim 1, wherein said passive display layer is stacked below said active display layer.

16. The display apparatus according to claim 15, wherein a first set of display sub-regions of said active display layer is switched to a transparent mode and a second set of display sub-regions of said passive display layer renders static digital content.

17. The display apparatus according to claim 1, wherein said active display layer is stacked below said passive display layer.

18. The display apparatus according to claim 17, wherein a first set of display sub-regions of said active display layer renders dynamic digital content and a second set of display sub-regions of said passive display layer is switched to a transparent mode.

19. A method for rendering digital content, the method comprising:
in a display apparatus:
dynamically controlling an active display layer and/or a passive display layer to activate a display region of a display screen of said display apparatus based on one or more parameters, wherein said active display layer corresponds to a first display technology and said passive display layer corresponds to a second display technology.

20. The method according to claim 19, wherein a first display resolution of said active display layer is greater than a second display resolution of said passive display layer.

21. A non-transitory computer-readable storage medium having stored thereon, a computer program having at least one code section for rendering digital content, the at least one code section being executable by a computer for causing the computer to perform steps comprising:
dynamically controlling an active display layer and/or a passive display layer to activate a display region of a display screen of said display apparatus based on one or more parameters, wherein said active display layer corresponds to a first display technology and said passive display layer corresponds to a second display technology.
